(19) United States
(12) Patent Application Publication
(10) Pub. No.: US 2020/0369873 A1
(43) Pub. Date: Nov. 26, 2020

(54) BIODEGRADABLE POLYMER COMPOSITE

(71) Applicant: SEOUL NATIONAL UNIVERSITY R&DB FOUNDATION, Seoul (KR)

(72) Inventors: Kyung Hyun AHN, Seoul (KR); Joung Sook HONG, Gyeonggi-do (KR); Ji Hwan KIM, Jeju-do (KR); Jung Hyun AHN, Seoul (KR)

(21) Appl. No.: 16/992,564

(22) Filed: Aug. 13, 2020

Related U.S. Application Data
(63) Continuation-in-part of application No. PCT/KR2019/002162, filed on Feb. 21, 2019.

(30) Foreign Application Priority Data
Feb. 21, 2018 (KR) 10-2018-0020315
Oct. 19, 2018 (KR) 10-2018-0125458

(51) Int. Cl. C08L 67/04; C08K 3/34; C08K 3/26; C08K 5/19; C08K 3/04; C08L 7/00; C08L 23/06; C08L 23/12; C08K 9/04

(52) U.S. Cl. CPC C08L 67/04; C08L 2201/06; C08K 3/26; C08K 5/19; C08K 3/04; C08L 7/00; C08L 23/06; C08L 23/12; C08K 9/04; C08K 2201/018; C08K 2003/265; C08K 2201/005; C08L 2207/062; C08L 2205/22; C08L 2205/02; C08K 3/346

(57) ABSTRACT

The present invention relates to a biodegradable polymer composite in which a small quantity of particles are dispersed in a first polymer matrix that is biodegradable, and in which a second polymer having a strong affinity to the particles is added thereto so as to allow the aggregation of the dispersed particles to be controlled, thereby forming a network structure, and thus the electrical properties, mechanical properties and the like of the biodegradable polymer composite can be improved even with only a small quantity of the particles.

### CROSS REFERENCE TO RELATED APPLICATIONS

This application is a continuation-in-part of PCT application PCT/KR2019/002162 filed Feb. 21, 2019 to AHN et al., which claims the benefit of priorities to Korean Patent Application Nos. 10-2018-0020315, filed on Feb. 21, 2018 and 10-2018-0125458, filed on Oct. 19, 2018, the entire disclosures of all three are incorporated herein by reference.

### FIELD OF THE INVENTION

In addition, this application is based on the research results conducted by the research project of National Research Foundation of Korea “Design and development of processing technology platform of eco-friendly nanocomposite” (Task No.: 2016R1E1A1A01942362).

The present invention relates to a biodegradable polymer composite having improved mechanical properties and electrical properties.

### BACKGROUND OF THE INVENTION

The biodegradable polymer produced from starch or aliphatic polyester as a raw material has a great advantage that it is biodegraded by bacteria or microorganisms and has much less waste treatment cost than that of a general plastic material, while exhibiting various physical properties of a general plastic material. Accordingly, various studies have been conducted on this.

Polylactic acid (PLA), which is one of the biodegradable polyester polymers, has attracted attention as an alternative to overcome the problem of environmental pollution due to depletion of petroleum resources and poor degradability of plastic products and is known to have environmentally friendliness, biocompatibility, resource savings and excellent thermal processing properties.

However, due to disadvantages such as brittleness, low decomposition rate, and low melt strength resulting from the hydrophobic structure of PLA, there are many limitations in applying PLA to actual industries. As a part of the strategy of overcoming these disadvantages, many methods have been studied, such as increasing plasticity by adding a liquid plasticizer. However, these methods have shown an additional problem that the plasticizing effect is not properly expressed due to problems such as shear stress and evaporation by heat in the melt mixing process. As another method to complement the brittleness of PLA, there is a method of toughening PLA by blending an elastic polymer having high ductility with PLA.

As a method for toughening PLA, a method of blending an elastic polymer having high ductility properties with PLA, such as natural rubber, has been tried. However, the polymer blend obtained by the above method has a problem of unexpected deterioration of physical properties, such as deterioration of impact strength due to the phase separation behavior due to incompatibility between a matrix polymer (PLA) and a dispersed phase polymer (natural rubber) and the resulting interface formation. Therefore, it is necessary to prevent deterioration of mechanical properties through morphology control of the blend of two polymers.

Meanwhile, in the case of using a dispersion stabilizer for morphology control, mechanical properties such as modulus of the blend may be deteriorated. For example, when controlling the morphology using spherical dispersion stabilizer particles, the amount of addition should be high, which may cause inhibition of flowability of the blend and reduction of processability and formability.

Therefore, it is necessary to develop a method capable of improving the morphology control and mechanical properties of a polymer blend even with a small quantity when manufacturing a biodegradable polymer blend.

### SUMMARY OF THE INVENTION

The problem to be solved by the present invention is to provide a biodegradable polymer composite capable of improving mechanical and electrical properties even if a smaller quantity of particles is added.

In order to solve the problem, the present invention provides a biodegradable polymer composite comprising a plurality of particles dispersed in a matrix of a biodegradable first polymer, wherein the particles are surrounded by a second polymer having a greater affinity to the particles than the biodegradable first polymer to be connected each other, or arranged in a line along a dispersed phase of the second polymer.

According to one embodiment, the surface energy difference between the first polymer and the particle is larger than the difference between the second polymer and the particle.

According to one embodiment, the surface energy difference between the first polymer and the particle is in the range of 1 to 20 mJ/m² and the surface energy difference between the second polymer and the particle is in the range of 1 to 20 mJ/m².

According to one embodiment, the surface energy difference between the first polymer and the particle may be 10 mJ/m² or more, and the surface energy difference between the second polymer and the inorganic particle may be less than 10 mJ/m².

According to one embodiment, when the dispersed phase is formed of the second polymer, the dispersed phase may be amorphous and have a long diameter of 10 μm or less.

According to one embodiment, the first polymer and the second polymer have a viscosity ratio (second polymer/first polymer) of 10 or less as measured at a temperature of 30° C. higher than a melting temperature of the two polymers or at a temperature of 100° C. higher than a glass transition temperature of the two polymers.

According to one embodiment, the first polymer may be selected from polylactic acid, polycaprolactone, polybutylene succinate, polybutylene adipate, polyethylene succinate, polyhydroxy alkylate and polyhydroxyalkanoate, or a mixture of two or more thereof.

According to one embodiment, the second polymer may be selected from natural rubber, polyolefin, polyolefin elastomer, or a mixture of two or more thereof.

According to one embodiment, the biodegradable polymer composite may comprise the first polymer and the second polymer in a weight ratio of 99:1 to 60:40.

According to one embodiment, the biodegradable polymer composite may comprise particles in an amount of 0.3 to 46% by weight based on the total weight of the first polymer and the second polymer.

According to one embodiment, the weight ratio of the particle to the second polymer may be 0.02:1 to 13:1.

When the particles are isotropic particles, the weight ratio of the particle to the second polymer may be 0.5:1 to 2:1, and when the particles are anisotropic particles, the weight ratio of the particle to the second polymer may be 0.02:1 to 0.4:1.

According to one embodiment, the average particle diameter of the particle may be 1 μm or less.

According to one embodiment, the particle may be at least one selected from the group consisting of clay, mica, talc, calcium carbonate, carbon black, carbon nanotubes, graphene, graphite, metal, and derivatives thereof.

According to one embodiment, the particle may be carbon black, clay, calcium carbonate coated with stearic acid, or a mixture of two or more thereof.

According to one embodiment, the particles may be anisotropic particles, and the anisotropic particles may be a mixture of hydrophobic organic clay and hydrophilic natural clay, or a mixture of hydrophobic calcium carbonate and hydrophilic calcium carbonate.

According to one embodiment, the natural clay may be composed of anionically charged aluminum or magnesium silicate layers, and cations of sodium ions (Na+) or potassium ions (K+) filling between the anionically charged aluminum or magnesium silicate layers.

According to one embodiment, the natural clay is montmorillonite, hectorite, saponite, beidellite, nontronite, vermiculite, halloysite, or a mixture of two or more thereof.

According to one embodiment, the organic clay may be organized by substituting ions existing on the surface or between the layers of the natural clay with hydrophobic functional groups.

According to one embodiment, the organic clay may be organized with a material having an alkylammonium ion containing an alkyl group having 1 to 10 carbon atoms or a hydrophobic material of ω-amino acid (NH₂(CH₂)ₙ₋₁COOH, where n is an integer from 2 to 18).

According to one embodiment, the hydrophobic material may be dimethyl dihydrogenated-tallow ammonium, dimethyl benzyl hydrogenated-tallow ammonium, dimethylhydrogenated-tallow (2-ethylhexyl) ammonium, or a mixture of two or more thereof.

According to one embodiment, the mixing weight ratio of the organic clay to the natural clay may be 30:70 to 70:30.

According to one embodiment, the mixing weight ratio of the hydrophobic calcium carbonate particle and the hydrophilic calcium carbonate particle may be 30:70 to 70:30.

### Effect of the Invention

According to the present invention, a small quantity of particles is added to a first polymer that is biodegradable, and a small quantity of a second polymer having a similar surface energy to the particles is added thereto so that the second polymer surrounds the particle to allow the particles to be connected each other and the particles to be arranged in a line, thereby forming a network structure. As a result, it is possible to provide a biodegradable polymer composite having improved mechanical properties as well as electrical properties even with only adding a small quantity of particles to the matrix polymer (first polymer).

### BRIEF DESCRIPTION OF THE DRAWINGS

FIG. 1 is a SEM image showing a change in the dispersed phase according to the composition of the PLA/cPCC/NR-based polymer composite according to one embodiment.

FIG. 2 is a TEM image showing the arrangement structure of particles according to the composition of the PLA/cPCC/NR-based polymer composite.

FIG. 3 is a SEM image showing the arrangement structure of particles according to the content of the dispersed phase of the PLA/cPCC/NR-based polymer composite.

FIG. 4 is a TEM image showing the arrangement structure of particles according to the content of the dispersed phase of the PLA/cPCC/NR based polymer composite as shown in FIG. 3.

FIG. 5 is the measurement results of the rheological properties according to whether NR is contained in the PLA/cPCC/NR-based polymer composite.

FIG. 6 is the measurement results of the rheological properties according to the NR content of the PLC/cPCC/NR-based polymer composite.

FIG. 7 is a SEM image showing the morphology of the PLA/ucPCC/NR-based polymer composite.

FIG. 8 is the measurement results of the rheological properties of the PLA/ucPCC/NR-based polymer composite.

FIG. 9 is a SEM image (a) and TEM image (b) of the PLA/cPCC/PP 85/15/8 composite.

FIG. 10 is a graph showing the viscosity of PLA and various PPs.

FIG. 11 is a SEM image of the PLA/cPCC/PP 85/15/8 composite according to the type of PP.

FIG. 12 is the measurement results of the rheological properties of the PLA/cPCC/PP-based polymer composite.

FIG. 13 is a SEM image showing the morphology of the PCL/PCC/PP-based polymer composite.

FIG. 14 shows a state in which organic clay (C20A) and natural clay (CNa+) having different surface properties are dispersed in a PLA/NR (7:3) blend, respectively.

FIG. 15 is a SEM image showing the morphology of the PCL/CB/PP-based polymer composite.

FIGS. 16A and 16B show the morphology change and the measurement results of rheological properties (G, G″) according to each content of organic clay (C20A) and natural clay (CNa⁺) added to the PLA/NR (7:3) blend, respectively.

FIGS. 17A and 17B show the measurement results of tensile strength and tensile elongation according to each content of organic clay (C20A) and natural clay (CNa⁺) added to the PLA/NR (7:3) blend, respectively.

FIG. 18 shows the degree of increase in tensile elongation when a mixture of organic clay (C20A) and natural clay (CNa⁺) added to the PLA/NR (7:3) blend.

FIGS. 19A and 19B show the measurement results of rheological properties (G′, G″) according to the single or combined use of organic clay (C20A) and natural clay (CNa⁺) added to the PLA/NR (7:3) blend, respectively.

FIG. 20 is SEM and TEM images showing the morphology of the polymer composite based on PLA/NR/anisotropic particles (mixture of organic clay and natural clay) according to Examples 12-2 and 12-3.

FIG. 21 is SEM and TEM images showing the morphology of the polymer composite based on PLA/NR/anisotropic articles (organic clay alone) according to Examples 13-2, 13-4 and 14-2.

FIGS. 22A and 22B are graphs showing tensile strength and tensile elongation according to the mixing ratio of PLA/NR and the content of organic clay for the polymer composite based on the PLA/NR/anisotropic particles (mixture of organic clay and natural clay), respectively.

FIG. 23 is a SEM image showing the morphology of a (PLA/PCL4)/CB4-based polymer composite.

FIG. 24 shows the measurement results of electrical conductivity of PLA/PCL/CB composites according to the carbon black content.

FIG. 25 shows the measurement results of electrical conductivity of the composite according to Comparative Example 16.

### DETAILED DESCRIPTION OF THE INVENTION

Since various modifications and variations can be made in the present invention, particular embodiments are illustrated in the drawings and will be described in detail in the detailed description. It should be understood, however, that the invention is not intended to be limited to the particular embodiments, but includes all modifications, equivalents, and alternatives falling within the spirit and scope of the invention. In the following description of the present invention, detailed description of known functions will be omitted if it is determined that it may obscure the gist of the present invention.

Since biodegradable polymers, especially biodegradable polyester polymers, have poor physical properties and processability, attempts have been made to disperse a large quantity of particles to compensate for this. However, the biodegradable polyester polymer has a low chemical affinity to the particles, and thus it is difficult to achieve uniform dispersion without surface modification of the added particles. In addition, there is a limit to improving dispersibility by surface modification. Also, a large quantity of particles must be added to improve physical properties such as electrical/thermal conductivity of the biodegradable polymer composite. However, when the content of the particles to be added is high, there is a problem in that, when the composite is melted, flowability is lowered, processability and moldability are lowered, and mechanical properties are also poor, making industrial application difficult.

In order to solve the problem, the present invention provides a biodegradable polymer composite comprising a plurality of particles dispersed in a matrix of a biodegradable first polymer, wherein the particles are surrounded by a second polymer having a greater affinity to the particles than the biodegradable first polymer to be connected each other, or arranged in a line along a dispersed phase of the second polymer.

In the present invention, a polymer (second polymer) that is incompatible with a biodegradable polymer (first polymer) is added so as to induce the aggregation of the particles and control the arrangement shape, thereby forming a network structure in the composite. Therefore, it is possible to improve the mechanical and electrical properties of the composite even with a small quantity of the particles. More specifically, since the affinity between the particle and the second polymer is greater than the affinity between the particle and the first polymer, the particles are surrounded by the second polymer when the second polymer is added. Accordingly, the particles surrounded by the second polymer may be aggregated or connected to each other to form a percolation structure in which particles are arranged in a line in the matrix of the first polymer, thereby forming a network.

That is, when the content of the second polymer is small, the particles surrounded by the second polymer are aggregated or connected to each other and arranged in a line, and when the content of the second polymer increases, the second polymer appears to form an amorphous dispersed phase and the particles are arranged along the boundary of this dispersed phase.

Since this arrangement is formed throughout the composite, it is possible to form a network between particles and even a lower content of particles can improve physical properties such as electrical conductivity and thermal conductivity.

Here, the term ‘percolation structure’ means that particles dispersed in a matrix material are contacted and connected to each other to form a network structure throughout the matrix material.

Therefore, even if a small quantity of particles is added compared to the existing biodegradable polymer composite, it is possible to improve electrical conductivity and thermal conductivity by forming a network structure of particles through particle arrangement control and thereby providing a passage for electrons and also it is possible to improve processability and formability.

In order to form the percolation structure as described above, it is essential to use a second polymer that is incompatible with the first polymer, which is a biodegradable polymer, and has greater affinity to particles.

Here, the affinity between the particle and the polymer means that the particle and the polymer have similar physicochemical surface properties (for example, surface energy). In the present invention, the difference in surface energy between the first polymer and the particle should be greater than the difference in surface tension between the second polymer and the particle. Here, surface energy (mJ/m²) is also referred to as surface free energy and can be used interchangeably with surface tension (mN/m).

When the surface energy difference between the first polymer and the particle is larger than the difference between the second polymer and the particle, it is advantageous for forming a percolation structure. The surface energy difference between the first polymer and the particle may be in the range of 1 to 20 mJ/m² and the surface energy difference between the second polymer and the particle may be in the range of 1 to 20 mJ/m² According to one embodiment, the difference in surface energy between the first polymer and the particle may be 10 mJ/m² or more, and the difference in surface energy between the second polymer and the particle may be less than 10 mJ/m².

Table 1 shows the surface free energy of various materials (Journal of Applied Polymer Science, Vol. 13, pp. 1741-1747 (1969); S.-B. Jeong, Y.-C. Yang, Y.-B. Chae, and B.-G. Kim, Mater. Trans., 50, 409 (2009); C. C. Ho and M. C. Khew, Langmuir, 16, 1407 (2000); http://www.surface-tension.de/solid-surface-energy.htm; Papirer, E., J. Schultz, and C. Turchi, 1984, Surface properties of a calcium carbonate filler treated with stearic acid, Eur. Polym. J. 20, 1155-1158; M. Sumita, K. Sakata, S. Asai, K. Miyasaka, H. Nakagawa, Polym. Bull. 1991, 25, 265; D. Wu, D. Lin, J. Zhang, W. Zhou, M. Zhang, Y. Zhang, D. Wang, B. Lin, Macromol. Chem. Phys. 2011, 212, 613).

TABLE 1

| | | Surface free |
|---|---|---|
| | | energy (SFE) at |
| | | 20° C. |
| | Name | [mJ/m²] |
| Particle | Calcium Carbonate, natural CaCO₃ | 93.3 |
| | Calcium Carbonate, Coated- | 34.8 |
| | Carbon black (untreated) | 18 |
| | Carbon black (treated) | 55 |
| | Natural sodium montmorillonite, | 60.6 |
| | Clay | |
| | Montmorillonite, coated- | 45.3 |
| First polymer* | Poly(lactic acid) PLA | 40~53 |
| | Polycaprolactone PCL | 50 |
| | Polybutylene succinate PBS | 49 |
| Second polymer* | Polybutylene succinate PBS | 49 |
| | Polycaprolactone PCL | 50 |
| | Polyethylene-linear PE | 35.7 |
| | Polyethylene-branched PE | 35.3 |
| | Polypropylene-isotactic PP | 30.1 |
| | Polyisobutylene PIB | 33.6 |
| | Polycarbonate PC | 34.2 |
| | Polyamide-12 PA-12 | 40.7 |
| | Poly(isoprene) | 32 |
| | Polyvinylchloride PVC | 41.5 |
| | Poly-a-methyl styrene PMS | 39.0 |
| | (Polyvinyltoluene PVT) | |
| | Polyvinyl fluoride PVF | 36.7 |
| | Polyvinylidene fluoride PVDF | 30.3 |
| | Polytrifluoroethylene | 23.9 |
| | P3FEt/PTrFE | |
| | Polytetrafluoroethylene PTFE | 20 |
| | (Teflon ™) | |
| | Polychlorotrifluoroethylene | 30.9 |
| | PCTrFE | |
| | Polyvinylacetate PVA | 36.5 |
| | Polyethylacrylate PEA | 37.0 |
| | Polyethylmethacrylate PEMA | 35.9 |
| | Polybutylmethacrylate PBMA | 31.2 |
| | Polyisobutylmethacrylate PIBMA | 30.9 |
| | Poly(t-butylmethacrylate) PtBMA | 30.4 |
| | Polyhexylmethacrylate PHMA | 30.0 |
| | Polytetramethylene oxide PTME | 31.9 |
| | (Polytetrahydrofurane PTHF) | |
| | Polydimethylsiloxane PDMS | 19.8 |
| | Polyetheretherketone PEEK | 42.1 |
| | Poly(2-ethylhexyl acrylate) PEHA | 31 |

In the above table, * means that in the case that the particle is a coated calcium carbonate it can be selected as a first polymer and a second polymer. If the type of the particles is changed, for example, if the particles are carbon black, the first polymer and the second polymer can be interchanged. In the above table, carbon black (treated) refers to carbon black subjected to physical and chemical surface treatment.

According to one embodiment, the particle size may be several tens of nanometers to tens of microns, for example, 10 μm or less, and preferably, an average particle diameter of 100 nm to 1 μm.

The particles are present in 0.3 to 46% by weight, or 0.3 to 35% by weight, or 0.3 to 25% by weight, or 1 to 25% by weight, or more than 5% by weight and 25% by weight or less based on the total weight of the first polymer and the second polymer. If the content of particles is too small, it is difficult to form the percolation structure throughout the composite, so the effect of improving mechanical and electrical properties is insignificant. If the content of particles is too high, the efficiency compared to the input amount may decrease.

The weight ratio of the first polymer and the second polymer in the composite according to the present invention may be 99:1 to 60:40, or 95:5 to 60:40, or 90:10 to 60:40, or 90:10 to 70:30. Since the second polymer is added to control the arrangement shape of the particles, it is not necessary to add excessively. If the content of the second polymer is too small, the effect of controlling the particle arrangement may be insignificant.

In addition, the particles and the second polymer may be mixed in a weight ratio of 0.02:1 to 13:1, or 0.1:1 to 10:1, or 0.2:1 to 5:1, or 0.5:1 to 2:1, or 0.5:1 to 1.5:1.

It is necessary that about 1/20 of the particle surface is contact with the second polymer. However, if the content of the second polymer is too small or too large, it is difficult to form a percolation structure.

Therefore, the particle content may vary depending on the shape of the particles. In the case of isotropic particles having an aspect ratio or a length to diameter ratio close to 1, for example, 0.8 to 1.2 or 0.9 to 1.1, the weight ratio of particle to second polymer may be 0.1:1 to 13:1, or 0.3:1 to 5:1, or 0.3:1 to 4:1, or 0.3:1 to 3:1, or 0.5:1 to 2:1, or 0.5:1 to 1.5:1. In addition, in the case of anisotropic particles having a large aspect ratio or a large difference in diameter and length, for example, anisotropic particles having an aspect ratio of less than 0.8 or more than 0.8, the percolation structure may be formed with a smaller content of the particles. Accordingly, the weight ratio of the particle to the second polymer may be in the range of 0.02:1 to 1:1, or 0.02:1 to 0.5:1, or 0.02:1 to 0.4:1.

When the contents of the first polymer, the second polymer and the particles satisfy the above range, it is advantageous to form a uniform dispersed phase and a percolation structure. According to a preferred embodiment, particles may be added with a content higher than the content of the second polymer which is a dispersed phase. Even in this case, the particles are thinly coated with the second polymer and aggregated, so that a percolation structure can be effectively formed. On the other hand, when the content of the second polymer increases, the second polymer forms a dispersed phase, which has a size of 10 μm or less (long diameter). Preferably, the size of the domain is 100 nm or more, more preferably 500 nm to 1 μm, which is advantageous for uniformly distributing the dispersed phase in the matrix.

The first polymer, which is a main matrix polymer, includes a biodegradable polymer having environmental friendliness, biocompatibility, resource saving, and excellent thermal processing characteristics. Examples of such a biodegradable first polymer include polylactic acid, polycaprolactone, polybutylene succinate, polybutylene adipate, polyethylene succinate, polyhydroxy alkylate, polyhydroxyalkanoate, or a mixture of two or more thereof, preferably polylactic acid, polycaprolactone, or a mixture of two or more thereof.

The second polymer as the dispersed phase is preferably non-polar when the first polymer is polar, and the second polymer is preferably polar when the first polymer is non-polar. In the polymer, covalent bonds are mostly formed. When the covalent bonds are formed, electrons are biased toward atoms having a large electronegativity due to the difference in the electronegativity of atom pairs, so that one side of the polymer has a negative charge and the other side has a positive charge, which causes polarity.

For example, the second polymer may be natural rubber, polyolefin, polyolefin elastomer, or a mixture of two or more thereof. Examples of polyolefin include polyethylene, polypropylene, polybutadiene, poly EVA (ethylene vinyl acetate), polyamide, polyethylene terephthalate, and the like.

In particular, natural rubber (NR) may be more preferred. Natural rubber (NR) is a material having high elasticity obtained from so-called rubber plants generally composed of polyisoprene as a main component. The unmodified natural rubber according to the present invention refers to natural rubber that is not modified, that is, not epoxidized or acrylic modified. When the dispersed phase polymer (second polymer) contains natural rubber, elastic properties such as elongation of the composite may be improved as the content of the natural rubber increases.

Polylactic acid (PLA), which represents a biodegradable polymer, has an advantage of being eco-friendly because it is biodegradable, but has a disadvantage that it is very brittle and cannot be used in various applications. Particularly, when a composite is manufactured by adding particles in order to improve various properties, brittleness is further increased due to particle addition. In this case, these shortcomings can be compensated by blending a second polymer (for example, natural rubber) that has a similar surface energy to the particle and is incompatible with the first polymer. For example, natural rubber may exhibit high elasticity because energy applied from the outside is stored in the form of thermal energy due to distortion of the double bond in the isoprene (cis-isoprene) repeat unit.

When the second polymer having a similar surface energy to the particle is added to the blend of the first polymer and the particle, the particles are surrounded by the second polymer having a similar surface energy to the particles among the two polymers, whereby the particles are aggregated and thus connected in a line, thereby forming a network structure. As a result, it is possible to improve electrical properties and thermal properties.

The particle can be used without limitation as long as it can improve physical properties such as electrical and thermal properties, for example, it may comprise at least one selected from the group consisting of clay, mica, talc, calcium carbonate, carbon black, carbon nanotubes, graphene, graphite, metal, and derivatives thereof. The derivatives may be those coated with organic acids. The metal may be selected from aluminum, silver, copper and platinum.

According to one embodiment, the calcium carbonate may be coated with fatty acid to improve compatibility with the dispersed phase, for example it may be coated with one or more saturated fatty acids selected from stearic acid, lauric acid, myristic acid, palmitic acid.

Especially, since the surface energy of the particles is lowered by such coating, the affinity to the second polymer can be further increased. For example, calcium carbonate has a surface energy of 93 mJ/m², which becomes about 35 mJ/m² after coating with stearic acid.

The particles may be isotropic or anisotropic particles.

According to another embodiment, the particles may be a mixture of anisotropic particles.

When a mixture of two or more particles having different surface properties is used, particles having different surface properties are not compatible with the first polymer and the second polymer, so that interaction between anisotropic particles is maximized to achieve formation of particle structure effectively. For example, when the particles positioned at the interface form a particle interface layer through interaction between anisotropic particles, the surface tension between the first polymer and the second polymer is lowered and the interface modulus is increased, thereby to provide effects of controlling the morphology and improving the mechanical properties concurrently.

In a preferred embodiment, the anisotropic particles specifically comprise a mixture of organic clays with hydrophobic surface properties and natural clays with hydrophilic surface properties.

The natural clay is composed of anionically charged aluminum or magnesium silicate layers, and cations of sodium ions (Na+) or potassium ions (K+) filling between the anionically charged aluminum or magnesium silicate layers. For example it includes montmorillonite, hectorite, saponite, beidellite, nontronite, vermiculite, halloysite, or a mixture of two or more thereof.

According to one embodiment, the organic clay is organized by substituting ions existing on the surface or between the layers of the natural clay with hydrophobic functional groups. For example, it is organized with a material having an alkylammonium ion containing an alkyl group having 1 to 10 carbon atoms or a hydrophobic material of ω-amino acid (NH₂(CH₂)ₙ₋₁COOH, where n is an integer from 2 to 18). Examples of the hydrophobic material to be used for organization include dimethyl dihydrogenated-tallow ammonium, dimethyl benzyl hydrogenated-tallow ammonium, dimethylhydrogenated-tallow (2-ethylhexyl) ammonium, or a mixture of two or more thereof.

When the clay substituted with the organic functional groups is added to the incompatible polymer blend, it is located at the interface of the two polymers and reduces the surface tension and increases the morphology control, including reduction of the droplet size of the dispersed phase. In addition, the organic clay may be arranged inside the first or second polymer phase.

On the other hand, the natural clay and the organic clay may exhibit different dispersion states in the polymer blend due to different surface properties. For example, FIG. 14 shows a state in which organic clay (C20A) and natural clay (CNa⁺) having different surface properties are dispersed in the PLA/NR (7:3) blend. From FIG. 14, it is found that the organic clay having a higher affinity to the hydrophobic polymer material has a smaller size of 1 μm unit and is more or less uniformly dispersed in the polymer blend (70:30 PLA:NR) (left side of FIG. 14). On the other hand, the natural clay has a very low dispersibility in the polymer blend even at the same content and maintains a size of 20 μm or more (right side of FIG. 14), so it has little effect on the structure of the polymer blend.

In particular, when the organic clay has a plate-like layered structure like nanoclay, it has a surface substituted with organic functional groups, so that it is easily peeled off within a hydrophobic polymer matrix. Moreover, even with a small content, the particle filling effect may be increased significantly and the blend structure may be changed. Furthermore, when it is located at the interface of the polymer blend, it is possible to control the morphology, thereby inducing toughening.

On the other hand, when the amount of organic clay added exceeds a certain content, mechanical properties such as tensile elongation of the polymer blend may be reduced due to aggregation of particles. However, it is difficult to predict a proper content of particles for increasing mechanical properties because a critical content of particles where particle aggregation occurs varies depending on the particle dispersion. For example, when the organic clay is added to the polymer blend in excess of 0.63% by weight, which is a critical content as determined according to percolation theory in which the organic clay is arranged in the polymer blend to form a network structure, the value of the storage modulus (G′) in a low frequency region is greater than the loss modulus (G″) when the particles are mixed at a content of about 2% by weight (see FIG. 14c). Therefore, it can be seen that in order to obtain the formation of the particle structure, it should be mixed in excess of the critical content. It means that the agglomeration of particles occurred partially. Although the value of G′ increases as the content increases, it is not advantageous in view of mechanical properties such as tensile elongation. That is, the tensile elongation of the polymer blend increases until the critical content of the organic clay, and when exceeding critical content, the tensile elongation rather decreases.

Such decrease in tensile elongation can be overcome by using in combination of natural clay. That is, when natural clay that does not exhibit percolation within a predetermined content range is added in combination with organic clay below the critical content of percolation, the unexpected increase in the tensile elongation can be achieved. This is because the particles are concentrated in the interface layer having a low chemical potential of polymer due to the interaction between the natural clay dispersed in the first polymer and the organic clay showing interface location specificity. As a result, the anisotropic clay particles located at the interface can increase bonding strength between polymer phases by physical wetting due to the particle surface energy between two polymer phases which have no thermodynamic affinity, from which resistance to external deformation can be increased and thus tensile elongation can be increased.

In addition, in order to improve the tensile elongation as described above, a mixture of inorganic particles having different surface properties, such as hydrophobic calcium carbonate (CaCO₃) particles coated with stearic acid (cPCC) and uncoated hydrophilic calcium carbonate (CaCO₃) particles (ucPCC) can be used.

In one embodiment of the present invention, the anisotropic particles may be present in 0.3 to 10% by weight of the total weight of the biodegradable polymer composite.

For example, when the anisotropic particles are the organic clay and the natural clay, these clays are present in 0.3 to 5% by weight, specifically 0.3 to 0.9%, or 0.5 to 0.9% by weight, or about 0.75% by weight of the total weight of the biodegradable polymer composite. When the above content is satisfied, it is advantageous in that the desired effect is achieved without causing a decrease in processability and formability due to excessive addition.

On the other hand, when the anisotropic particles are hydrophobic calcium carbonate particles and hydrophilic calcium carbonate particles, they have lower anisotropy (aspect ratio) than that of the clay and no peeling phenomenon, so the content is slightly increased to achieve the intended effect. However, due to the combined addition of hydrophobic particles and hydrophilic particles, it is possible to achieve the increased dispersion effect in a smaller amount compared to the conventional addition amount. Accordingly, these calcium carbonate particles may be contained in an amount of 1 to 10% by weight, such as 3 to 8% by weight, or 3 to 6% by weight.

In addition, the mixing weight ratio of the organic clay and the natural clay may be 30:70 to 70:30, or 50:50 to 60:40. When the mixing ratio range is satisfied, it is advantageous in terms of controlling the morphology and improving the tensile elongation. Similarly, the mixing weight ratio of the hydrophilic calcium carbonate particles and the hydrophobic calcium carbonate particles may be 30:70 to 70:30, or 50:50 to 60:40.

In the biodegradable polymer composite according to the present invention, the second polymer may be added simultaneously with dispersing the particles in the first polymer and then melt mixed, or the second polymer may be dispersed in a melt mixed state in the particle/first polymer masterbatch. That is, as long as the second polymer is added to the particle/first polymer blend and mixed with each other, any method can be used without limitation.

For example, the blending process may be performed at 180 to 230° C., which is about 30 to 70° C. higher than the melting point of the first polymer (for example, 155 to 165° C. for polylactic acid), and specifically 190 to 200° C. and at a speed of 50 to 150 rpm, specifically 80 to 100 rpm for 3 to 10 minutes, such as 7 minutes.

According to a preferred embodiment, when the first polymer, the second polymer and the inorganic particles are blended, the shear rate is as high as 90 s⁻¹ or more, and the viscosity ratio of the second polymer/first polymer is 10 or less, preferably 5 or less, most preferably 1 or less at a processing temperature, for example, 190° C., which are advantageous for forming a uniform dispersed phase. In addition, the first polymer and the second polymer have a viscosity ratio (second polymer/first polymer) of 10 or less, more preferably 5 or less, and most preferably 1 or less, as measured by a vibration test using a rheometer at a predetermined mixing processing temperature and agitation speed, for example at a mixing processing temperature of 190° C. and a agitation speed of 100 rpm because when the first polymer is polylactic acid, it has a melting temperature of 160° C., and when the second polymer is natural rubber (NR), it does not have the melting temperature. Here, the mixing processing temperature is at least 30° C. higher than a melting temperature of the first polymer and the second polymer (a higher melting temperature, if both have a melting temperature) or at least 100° C. higher than a glass transition temperature (a higher glass transition temperature, if both have a glass transition temperature). In addition, viscosity means complex viscosity. When the viscosity ratio of the second polymer/first polymer exceeds 10, there is not active contact between the second polymer and the particles and the particle aggregation phenomenon is very strongly exhibited, and thus the formation of the particle percolation structure may be suppressed, which is not preferable.

Hereinafter, embodiments of the present invention will be described in detail so that those skilled in the art to which the present invention pertains can easily practice. However, the present invention can be implemented in many different forms and is not limited to the embodiments described herein. In addition, in the following examples, the content is based on weight unless otherwise specified.

### Examples 1 to 7

Polylactic acid (PLA, 4032D, Natureworks, USA) as a first polymer forming a matrix, precipitated calcium carbonate coated with stearic acid (cPCC, socal, Imersy, France) and natural rubber (NR, CSR5, CRK Co., Korea) were mixed at the ratios shown in Table 2A. All materials were dried in a vacuum oven at 80° C. for 8 hours or more to remove moisture. The moisture-removed materials were weighed to the contents shown in Table 2A, all the materials were placed in a zipper bag and hand-mixed, and all hand-mixed materials were introduced to an internal mixer (Rheocomp mixer 600, MKE, Korea), followed by mixing at 10 rpm for 2 minutes and then at 100 rpm for 6 minutes. The shear rate was 90 s⁻¹ (mixer rotation speed 100 rpm), and the mixing temperature was maintained at 190° C. The viscosity of the first polymer and the second polymer was measured by a vibration test using a rheometer (DHR-3, TA instrument, USA) at 190° C. As a result, the viscosity of the first polymer and the second polymer is 1740 Pa·s and 2150 Pa·s, respectively, and the viscosity ratio was 1.2.

### Comparative Example 1

A polymer composite was prepared in the same manner in Example 1, except that polylactic acid (PLA, 4032D, Natureworks, USA) and natural rubber (NR, CSR5, CRK Co., Korea) were mixed in a weight ratio shown in Table 2A below.

### Comparative Examples 2 to 3

A polymer composite was prepared in the same manner in Example 1, except that polylactic acid (PLA, 4032D, Natureworks, USA) and precipitated calcium carbonate coated with stearic acid (cPCC, socal, Imersy, France) were mixed in a weight ratio shown in Table 2A below.

Tables 2A and 2B below show the mixing ratio by weight and the mixing ratio by volume, respectively. In Tables 2A and 2B, the conversion between weight and volume was calculated based on a density of the polymer of 1 and a density of the cPCC particle of 2.77.

Here, ‘PLA’ refers to polylactic acid, ‘cPCC’ refers to precipitated calcium carbonate coated with stearic acid, and NR refers to natural rubber. The cPCC particle has an average particle diameter of 100 nm and a distorted spherical shape. The surface energy of PLA, cPCC and NR (polyisoprene) is 47 mJ/m², 34.8 mJ/m² and 32 mJ/m², respectively.

TABLE 2A

| By weight | PLA | NR | cPCC | cPCC:NR |
|---|---|---|---|---|
| Comparative | 92.6 | 7.4 | — | — |
| Example 1 | | | | |
| Comparative | 100 | — | 20.7 | — |
| Example 2 | | | | |
| Comparative | 100 | — | 15.4 | — |
| Example 3 | | | | |
| Example 1 | 92.4 | 7.6 | 2.6 | 0.34:1 |
| Example 2 | 91.5 | 8.5 | 13.3 | 1.56:1 |
| Example 3 | 90.4 | 9.6 | 25 | 2.6:1 |
| Example 4 | 89.3 | 10.7 | 34.9 | 3.26:1 |
| Example 5 | 88 | 12 | 45.3 | 3.78:1 |
| Example 6 | 97 | 3 | 37 | 12.33:1 |
| Example 7 | 79 | 21 | 37.8 | 1.8:1 |

TABLE 2B

| By volume | PLA | cPCC | NR |
|---|---|---|---|
| Comparative | 100 | — | 8 |
| Example 1 | | | |
| Comparative | 85 | 15 | — |
| Example 2 | | | |
| Comparative | 88 | 12 | — |
| Example 3 | | | |
| Example 1 | 99 | 1 | 8 |
| Example 2 | 95 | 5 | 8 |
| Example 3 | 90 | 10 | 8 |
| Example 4 | 88 | 12 | 8 |
| Example 5 | 85 | 15 | 8 |
| Example 6 | 88 | 12 | 2 |
| Example 7 | 88 | 12 | 23 |

### Experimental Example 1: Size Change and Particle Arrangement Shape of Dispersed Phase in Three-Phase Composite

Morphology observation was performed using FE-SEM (Carl Zeiss, Germany) and HR-TEM (JEOL Ltd, Japan) to observe the size change and particle arrangement shape of the dispersed phase in the three-phase composite. The specimen was cooled with liquid nitrogen and then was cut to observe the cross section.

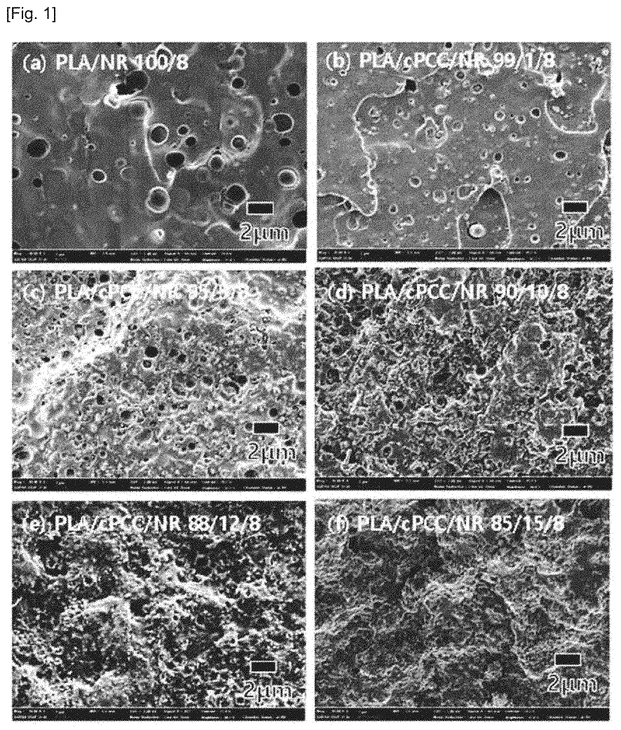

FIG. 1 shows a change in the dispersed phase of the polymer composites prepared in Comparative Example 1 and Examples 1 to 5. As can be seen in FIG. 1 (a) (PLA/NR), when 7.4 wt % (8% by volume relative to PLA+NR, hereinafter, based on volume) of NR was added as a second polymer that is incompatible, amorphous dispersed phase having a size of about 1.6 μm was observed. It is found that as the content of the particles increases to 1, 5, and 10% by volume (2.6, 13.3 and 25% by weight, respectively)(Examples 1 to 3), the size of the dispersed phase decreases and the spherical shape of the dispersed phase is distorted (FIG. 1(b)-(d)). In Examples 4 and 5, in which the content of the particles is 34.9% by weight (12% by volume) or more, it is found that the size of the dispersed phase is reduced to an indistinguishable level ((e) to (f) in FIG. 1). That is, it can be confirmed that addition of the particles (cPCC) increases the compatibility of NR and PLA.

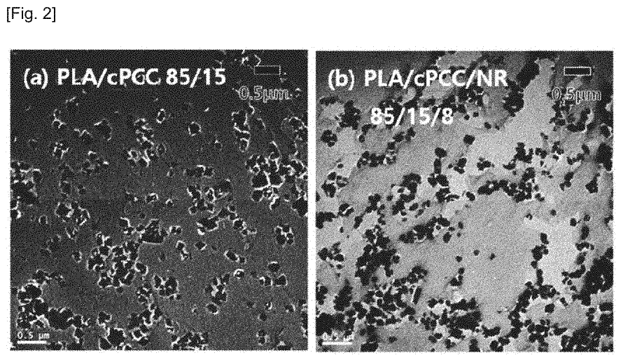

FIG. 2 shows the results of TEM measurement for more accurate analysis of the arrangement structure of the particles and the size of the dispersed phase. As can be seen from the results of FIG. 2, it is found that in the PLA/cPCC composite (Comparative Example 2), agglomeration between particles is observed and the particles are randomly distributed. On the other hand, in the PLA/cPCC/NR composite (Example 5), the particles are linearly connected at the PLA/NR interface. That is, particles arranged along the interface of the dispersed phase are connected throughout the entire area to form a percolation structure. In addition, it can be seen that the compatibility with PLA increases as the size of the dispersed phase decreases to about 500 nm.

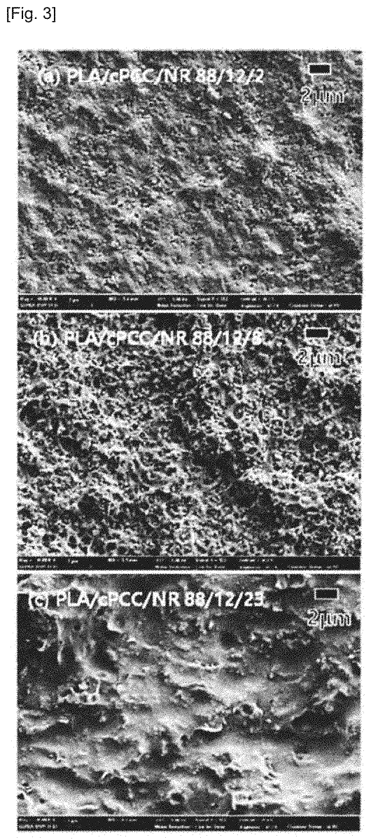

In FIG. 3, the SEM image was observed with increasing the content of NR after fixing the content of the particle constant in order to confirm the arrangement structure of the particles according to the content of the dispersed phase (Examples 4, 6, and 7). When the content of NR is low (Example 6, 2% by volume (3% by weight) of NR), the particle arrangement on the surface is not noticeable. As the content of NR increases to 8% by volume (10.7% by weight, Example 4), the aggregation of particles on the surface become noticeable. When the content of NR increases to 23% by volume (21% by weight), the particles are not noticeable again on the surface.

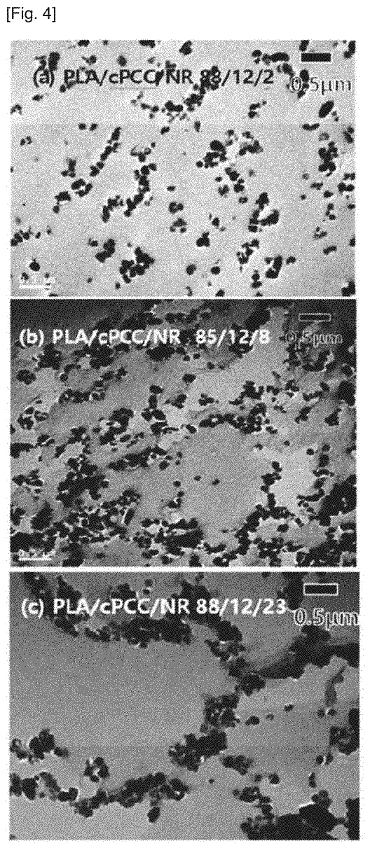

FIG. 4 shows the results of TEM measurement for more accurate analysis of the arrangement structure of the particles according to the dispersed phase. When the content of NR is 3% by weight (2% by volume), a group of particles arranged in a length of about 0.5 μm is observed. In addition, it can be seen that as the content of NR increases, the interface of PLA/NR becomes larger and particles are arranged at the interface to have a structure in which the particles are linearly connected.

### Experimental Example 2: Rheological Properties

Rheological properties were measured using a controlled stress rheometer (DHR-3, TA instrument, USA). Before measuring the rheological properties, a specimen having a diameter of 25 mm and a thickness of 1 mm was prepared using a hot press (CH4386, Carver) at 190° C. After checking the linear viscoelastic region by an amplitude sweep test, a frequency sweep test was performed within the region. All measurements were conducted at 180° C.

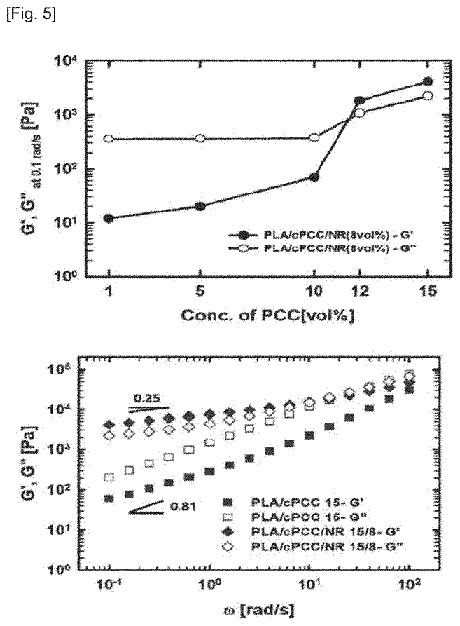

FIG. 5 shows the measurement results of the rheological properties for the composite of Comparative Example 2 (PLA/cPCC 85/15 volume ratio) and Example 5 (PLA/cPCC/NR 85/15/8 volume ratio).

Referring to FIG. 5, the storage modulus rapidly increases from 12% by volume and reverses the loss modulus, as if the size of the dispersed phase suddenly changes and the particle arrangement changes at 12% by volume (34.9% by weight) of content of particles in Experimental Example 1.

In addition, it can be seen that when 8% by volume of NR is added to the PLA/cPCC composite, the storage modulus increases very rapidly at low frequencies and the slope decreases in whole frequency domain. This means that PLA/cPCC exhibits liquid-like behavior and PLA/cPCC/NR exhibits solid-like behavior.

From the results of FIG. 5, it can be determined that the percolation structure of particles is formed throughout the three-phase composite from morphology as well as rheological properties.

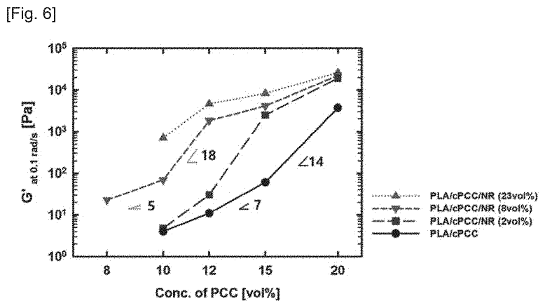

FIG. 6 shows the measurement results of the rheological properties according to the content of NR.

Referring to the rheological properties of only the PLA/cPCC composite in FIG. 6, it can be seen that the G′ (storage modulus) rapidly increases when the content of particles is 20% by volume (45.3% by weight) or more. However, in the case that NR is added in an amount of 2% by volume (3% by weight) and 8% by volume (12% by weight), respectively, a rapid increase in rheological properties can be seen at 15% by volume (37.8% by weight) and 12% by volume (34.9% by weight) of particles. That is, when the addition of NR induces the aggregation of particles, the particle content required to form a percolation structure can be reduced, from which it is possible to design proper contents of the particles and the dispersed phase. Therefore, it is possible to form a percolation structure even with a lower particle content.

### Experimental Example 3: Mechanical Properties

Mechanical properties of the polymer composite were measured through ASTM D639 type B with UTM (LF plus, Lloyd instruments Ltd). Before measuring the mechanical properties, a dog-bone-shaped specimen was prepared using a hot press. The average value was obtained after at least 8 times measurement for each specimen. The measurement results are shown in Table 3 below.

TABLE 3

| Composite volume ratio | Elongation at break [%] |
|---|---|
| PLA | 21.2 |
| PLA/cPCC 88/12 (Comparative Example 3) | 12.0 |
| PLA/cPCC/NR 88/12/8 (Example 4) | 18.6 |
| PLA/cPCC/NR 88/12/23 (Example 7) | 84.5 |

As can be seen from Table 3, in the case of PLA/cPCC composite, elongation at break and tensile strength are significantly reduced by half compared to PLA. On the other hand, when 8% by volume of NR is added, the elongation at break is recovered to some extent, and in the case of PLA/cPCC (12% by volume)/NR (23% by volume) (PLA/NR/cPCC 79/21/37.8 weight ratio) composite, elongation at break rapidly increases to 84.5%, which indicates complementation of brittleness (approximately 398% increase relative to PLA).

### Comparative Example 4

A polymer composite was prepared in the same manner as in Example 5, except that uncoated precipitated calcium carbonate (PCC, socal, Imersy, France) was used. Hereinafter, uncoated calcium carbonate is referred to as ucPCC. The surface energy of ucPCC is 93.3 mJ/m².

### Comparative Example 5

A polymer composite was prepared in the same manner as in Example 7, except that uncoated precipitated calcium carbonate (PCC, socal, Imersy, France) was used.

### Experimental Example 4: Morphology of PLA/ucPCC/NR

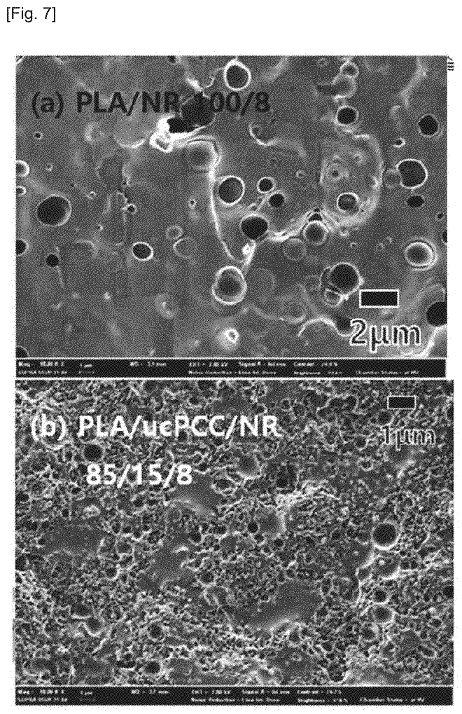

FIG. 7 shows the measurement results of morphology of PLA/ucPCC/NR.

From the results of FIG. 7, it is found that in the case that the uncoated PCC particles are added to the PLA/NR (8% by volume) (7.4% by weight) with the same content as the coated PCC particles, the dispersed phase is still maintained at a size of 1 μm or more as shown in FIG. 7 (b). This is because the uncoated particles have a larger surface energy difference with the second polymer that is a dispersed phase, compared to the coated particles, and thus less contributes to improving the compatibility between the first polymer and the second polymer and therefore formation of the percolation structure of the particles does not occur efficiently.

### Experimental Example 5: Rheology Properties of PLA/ucPCC/NR

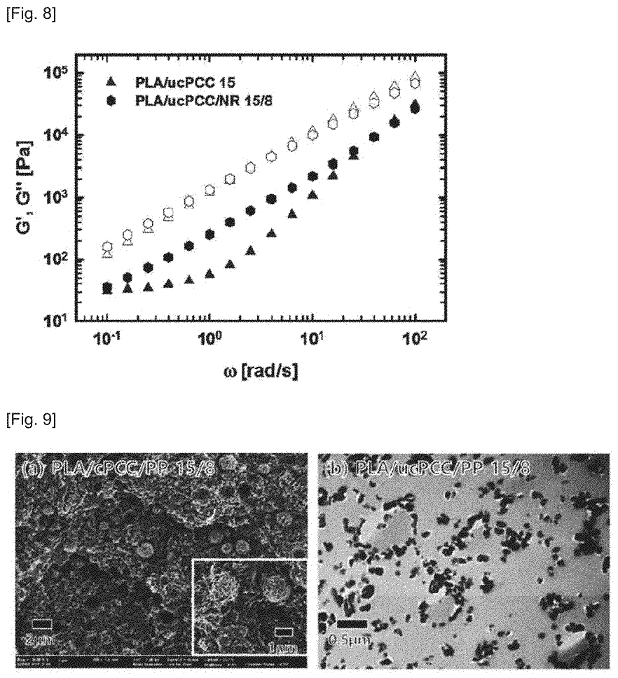

FIG. 8 shows the measurement results of rheological properties of PLA/ucPCC/NR.

When uncoated PCC particles are used, there is no significant change in storage modulus and loss modulus among rheological properties, as if the linear arrangement of particles is not formed in the observation of the morphology of the three-phase composite in Experimental Example 4 (see FIG. 7). Therefore, it can be seen that the fatty acid coating changes the surface energy of the particles and has a significant effect on the arrangement of the particles in the three-phase composite.

That is, the coated PCC particles are mainly located at the PLA/NR interface or in the NR domain, reduce the size of the dispersed phase domain and allow the percolation structure of the PCC particles to be formed effectively. However, the uncoated particles do not interact with NR and are mainly located in PLA, and do not affect the size of the dispersed phase domain and also do not allow the linear arrangement structure of the particles to be formed.

### Experimental Example 6: Mechanical Properties Depending on Coating

Table 4 shows the results of observing the mechanical properties for the case of using the coated particles (Example 7) and the case of using the uncoated particles (Comparative Example 5).

TABLE 4

| Composite volume ratio | Elongation at break [%] |
|---|---|
| PLA | 21.2 |
| PLA/cPCC/NR 88/12/23 (Example 7) | 84.5 |
| PLA/ucPCC/NR 88/12/23 (Comparative | 18.3 |
| Example 5) | |

As shown in Table 4, in the case of PLA/cPCC (12% by volume)/NR(23% by volume), elongation at break rapidly increases to 84.5%, thereby improving brittleness which is a shortcoming of the biodegradable polymer (398% increase relative too PLA). On the other hand, in the case of PLA/ucPCC (12% by volume)/NR(23% by volume), elongation at break is only 18.3%, which is reduced by 86% compared to PLA.

### Example 8: PLA/cPCC/PP

A polymer composite was prepared in the same manner as in Example 1, except that a non-polar polymer PP (polypropylene) (30.1 mJ/m² of surface energy), which is expected to have a surface energy similar to NR known to be non-polar, was used, and the volume ratio of PLA/cPCC/PP was 85/15/8 (88/45.3/12 weight ratio).

At this time, PP (2150, PolyMirae) having a complex viscosity similar to that of NR was used.

FIG. 9 is SEM (a) and TEM (b) images for the PLA/cPCC/PP 85/15/8 composite. Although the size of the dispersed phase was not completely reduced, it was confirmed that the particles were arranged at the interface of the dispersed phase. The particles aggregated around the dispersed phase may be connected via particles distributed in a matrix to form a percolation structure.

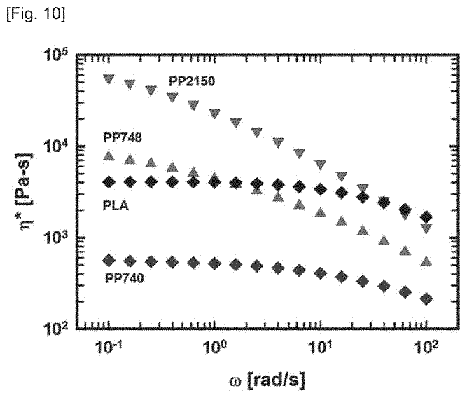

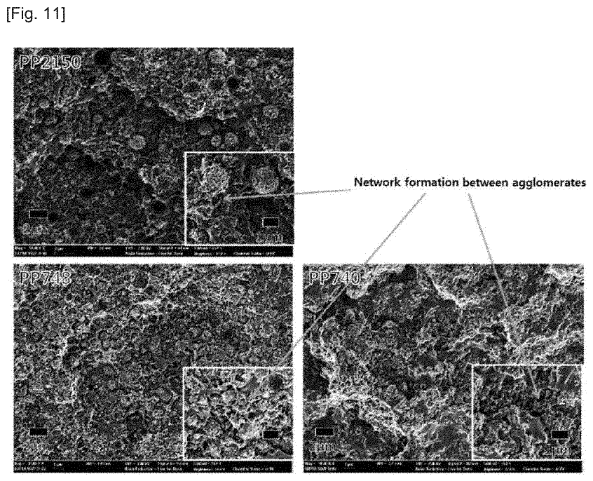

Meanwhile, FIG. 10 is a graph showing the viscosity of PLA and various PPs, and FIG. 11 is a SEM image of PLA/cPCC/PP 85/15/8 composite according to the type of PP. The viscosity ratio relative to PLA is 0.8 for PP2150, 0.3 for PP748, and 0.1 for PP740 (viscosity is 1380, 560 and 220 Pa. S, respectively). As shown in FIG. 11, it can be seen that when the viscosity ratio is 10 or less under the processing conditions (temperature 190° C.), particles are aggregated by the second polymer, thereby forming a percolation structure.

### Experimental Example 7: Rheological Properties of PLA/cPCC/PP

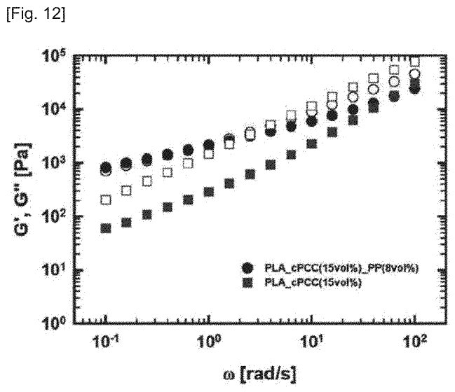

FIG. 12 shows the measurement results of the rheological properties of PLA/cPCC/PP. As can be seen from the results of FIG. 12, it is found that when PP was added to the PLA/cPCC composite, the storage modulus rapidly increases and reverses the loss modulus as in the case of addition of NR. Although the degree of increase is different from that when NR is added, but the behavior is the same, which means that in the PLA/cPCC/PP composite like the PLA/cPCC/NR composite, the particles are arranged at the interface of the dispersed phase to form a percolation structure of the particles, so that rheological properties can be increased.

### Example 9: PCL/cPCC/PP 85/15/6 Volume Ratio (88/45.3/12 Weight Ratio)

A polymer composite was prepared in the same manner as in Example 1, except that PCL (polycaprolactone, Capa6800, Perstorp) was used as a matrix polymer instead of PLA, PP was used as a dispersed phase, and PCL/cPCC/PP was mixed in an 85/15/6 volume ratio (88/45.3/12 weight ratio). The surface energy of PCL is 50 mJ/m².

### Comparative Example 6: PCL/ucPCC 85/15 Volume Ratio (100/53 Weight Ratio)

A polymer composite was prepared in the same manner as in Comparative Example 2, except that PCL (polycaprolactone, Capa6800, Perstorp) was used as a matrix polymer instead of PLA, and uncoated precipitated calcium carbonate (PCC, socal, Imersy, France) was used.

### Comparative Example 7: PCL/cPCC 85/15 Volume Ratio (100/53 Weight Ratio)

A polymer composite was prepared in the same manner as in Comparative Example 2, except that PCL (polycaprolactone, Capa6800, Perstorp) was used as a matrix polymer instead of PLA.

### Comparative Example 8: PCL/ucPCC/PP 85/15/6 Volume Ratio (88/45.3/12 Weight Ratio)

A polymer composite was prepared in the same manner as in Example 1, except that PCL (polycaprolactone, Capa6800, Perstorp) was used as a matrix polymer instead of PLA, PP was used as a dispersed phase, and uncoated precipitated calcium carbonate (PCC, socal, Imersy, France) (ucPCC) was used, and PCL/ucPCC/PP was mixed in an 85/15/6 volume ratio (88/45.3/12 weight ratio).

### Experimental Example 8: Morphology of PCL/PCC/PP

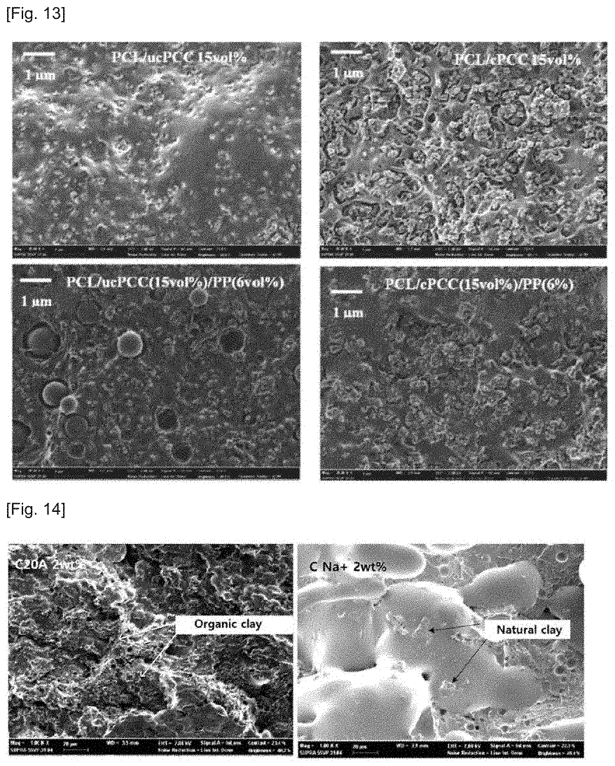

FIG. 13 shows the measurement results of the morphology of the PCL/PCC/PP-based polymer composite.

From the results of FIG. 13, it is found that when using PCL, the use of uncoated ucPCC particles maintains the domains (droplets) of the dispersed phase at a size of approximately 1 μm and allows the particles to be evenly distributed throughout the composite. On the other hand, the use of the coated PCC particles (cPCC) allows the dispersed phase to be reduced to a size that is not clearly observed and allows the particles to be agglomerated, thereby forming a percolation structure.

### Example 10: PCL/CB/PP 94.6/5.4/6

A polymer composite was prepared in the same manner as in Example 1, except that PCL (polycaprolactone, Capa6800, Perstorp) was used as a matrix polymer instead of PLA and carbon black (CB, xc72r, Vulcan) particles which are carbon-based nanoparticles were added as inorganic particles, and PCL/CB/PP was mixed in a volume ratio of 94.6/5.4/6 (calculated based on a density of the polymer of 1 and a density of CB of 1, the volume ratio and the weight ratio are the same). The surface energy of the carbon black particles is 18 mJ/m².

### Example 11: PCL/CB/PP 87/13/6

A polymer composite was prepared in the same manner as in Example 1, except that PCL (polycaprolactone, Capa6800, Perstorp) was used as a matrix polymer instead of PLA, PP was used as a dispersed phase, and carbon black (CB, xc72r, Vulcan) particles which are carbon-based nanoparticles were added as inorganic particles, and PCL/CB/PP was mixed in a ratio of 87/13/6.

### Comparative Example 9: PCL/CB 94.6/5.4

A polymer composite was prepared in the same manner as in Comparative Example 2, except that PCL (polycaprolactone, Capa6800, Perstorp) was used as a matrix polymer instead of PLA, PP was used as a dispersed phase, and carbon black (CB, xc72r, Vulcan) particles which are carbon-based nanoparticles were added as inorganic particles, and PCL/CB was mixed in a ratio of 94.6/5.4.

### Experimental Example 9: Morphology of PCL/CB/PP

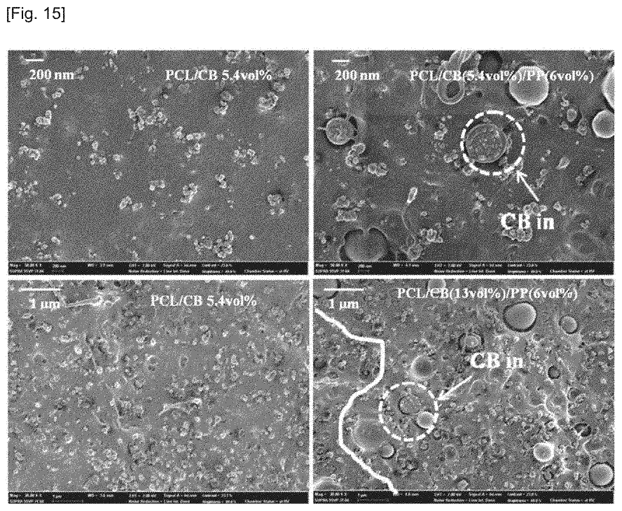

FIG. 15 shows the measurement results of the morphology of the PCL/CB/PP-based polymer composite. The part in the white line in FIG. 15 indicates that the particles are connected to form a 3D network structure.

In FIG. 15, when polypropylene as a dispersed phase is added and mixed into the PCL/CB composite, agglomeration of particles (carbon black) occurs in the dispersed phase (droplet) of the PP polymer.

### <Example 12> Preparation of Biodegradable Polymer Composite Based on PLA/NR/Anisotropic Particles (Organic/Natural Clay Mixture)

Polylactic acid (PLA, 4032D, Mn=90.00 g/mol, Mw=181,000 g/mol, Natureworks, USA) as a first polymer forming a matrix, and natural rubber (NR, CSR5, Cambodia) as a second polymer forming a dispersed phase were used. Organic clay (Cloisite 20A, density=1.77 g/cc, Southern Clay Product, USA) having two hydrogenated tallow (HT) groups and two methyl groups as anisotropic particles and natural clay (Cloisite CNa⁺, density=2.86 g/cc, BYK, USA) were used, and all materials were dried in a vacuum oven at 80° C. for one day to remove moisture.

The materials were mixed at 100 rpm for 7 minutes at 200° C. using an intensive mixer (Rheocompmixer 600, MKE, Korea) in the amounts shown in Table 5 below.

TABLE 5

| | | | Anisotropic particle | | | |
|---|---|---|---|---|---|---|
| | | | (0.75% by weight based on 100 parts by | | | |
| | | | weight of PLA and NR) | | | |
| Part by weight | PLA | NR | Organic clay (C20A) | | Natural clay (CNa⁺) | |
| Example 12-1 | 90 | 10 | 0.45% | by weight | 0.3% | by weight |
| Example 12-2 | 70 | 30 | | | | |
| Example 12-3 | 70 | 30 | 0.3% | by weight | 0.45% | by weight |

### <Comparative Example 10> PLA/NR Polymer Blend

A polymer blend of PLA/NR was prepared in the same manner as in Example 12-2, except that the anisotropic particles were not mixed.

### <Example 13> Biodegradable Polymer Composite Based on PLA/NR/Organic or Natural Clay

A biodegradable polymer composite was prepared in the same manner as in Example 12-2, except that the organic clay or natural clay was mixed alone in the amounts shown in Table 6 below.

TABLE 6

| | | | Organic clay or natural clay |
|---|---|---|---|
| | | | (based on 100 parts by |
| Part by weight | PLA | NR | weight of PLA and NR) |
| Comparative | 70 | 30 | — |
| Example 10 | | | |
| Example 13-1 | 70 | 30 | Natural clay (CNa⁺) 0.3% by weight |
| Example 13-2 | 70 | 30 | Organic clay (C20A) 0.45% by weight |
| Example 13-3 | 70 | 30 | Natural clay (CNa⁺) 0.75% by weight |
| Example 13-4 | 70 | 30 | Organic clay (C20A) 0.75% by weight |

### <Experimental Example 10> Measurement of Morphology, Rheological Properties and Mechanical Properties of PLA/NR Polymer Blends According to the Content of Organic Clay or Natural Clay

To analyze the effect of organic clay and natural clay on the structural change and rheological properties of the PLA/NR polymer blend, materials were mixed in the same manner as in Example 12-2 in the amounts shown in Table 7 below to prepare a sample.

TABLE 7

| | | | Organic clay or natural clay |
|---|---|---|---|
| | | | (based on 100 parts by |
| Part by weight | PLA | NR | weight of PLA and NR) |
| Comparative | 70 parts | 30 parts | 0% by weight |
| Example 11 | by weight | by weight | |
| Example 14-1 | | | Organic clay (C20A) |
| | | | 0.5% by weight |
| Example 14-2 | | | Organic clay (C20A) |
| | | | 2% by weight |
| Example 14-3 | | | Organic clay (C20A) |
| | | | 5% by weight |
| Example 14-4 | | | Natural clay (CNa⁺) |
| | | | 0.5% by weight |
| Example 14-5 | | | Natural clay (CNa⁺) |
| | | | 2% by weight |
| Example 14-6 | | | Natural clay (CNa⁺) |
| | | | 5% by weight |

Each sample prepared was annealed for 6 minutes in a hot press (CH4386, Carver) at 200° C. and then a specimen was prepared using a disc-like mold having a diameter of 25 mm and a thickness of 0.4 mm. At this time, the molding temperature was 200° C., and the molding time was 6 minutes.

The cross section of the specimen was observed with a High Resolution-Transmission Electron Microscope (TEM) (JEOL Ltd, Japan) to analyze the morphology change according to the clay content.

In addition, the change in the rheological properties (dynamic rheological properties) for the specimen was measured using a strain-controlled rheometer RMS800 (Rheometrics, USA). At this time, all measurements were performed in a linear viscoelastic region at 190° C., and frequency experiments were performed at from 0.1 rad/s to 100 rad/s with a strain value between 1% and 15%.

On the other hand, the mechanical properties of the specimen were measured using a UTM (LF plus, Lloyd instruments Ltd) after cutting to the dimension of ASTM D639 Type V.

FIGS. 16A and 16B show the morphology change and the measurement results of rheological properties (storage modulus (G′) and loss modulus (G″)) according to each content of organic clay (C20A) and natural clay (CNa⁺) added to the PLA/NR (7:3) blend, respectively. On the other hand, FIG. 16B is a diagram showing G and G″ of 0.1 rad/s in the frequency experiment, and the reason for selecting the lowest value frequency of 0.1 rad/s in the frequency experiment is because it was judged that a behavior at a long time scale reflects a behavior of the overall polymer and this behavior is correlated with the overall morphology. It can be seen from FIGS. 16aA and 16B that the organic clay (C20A) significantly changes the morphology and rheological properties of the polymer blend.

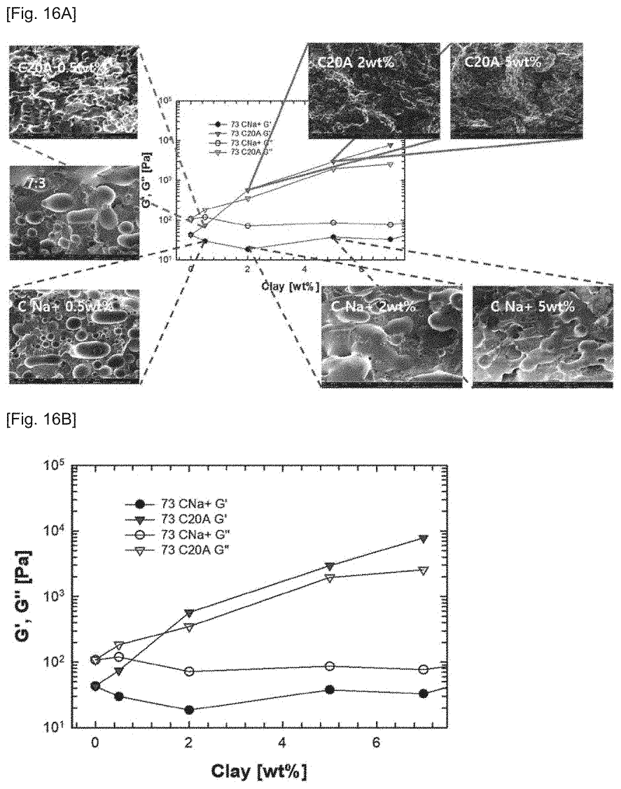

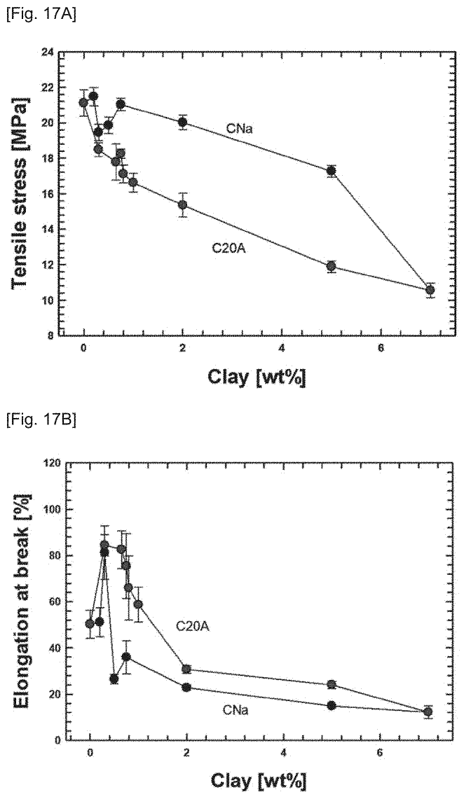

FIGS. 17A and 17B show the measurement results of tensile strength and tensile elongation according to each content of organic clay (C20A) and natural clay (CNa⁺) added to the PLA/NR (7:3) blend, respectively.

### <Experimental Example 11> Measurement of Changes in Mechanical Properties of PLA/NR Polymer Blends According to the Mixture of Organic Clay and Natural Clay

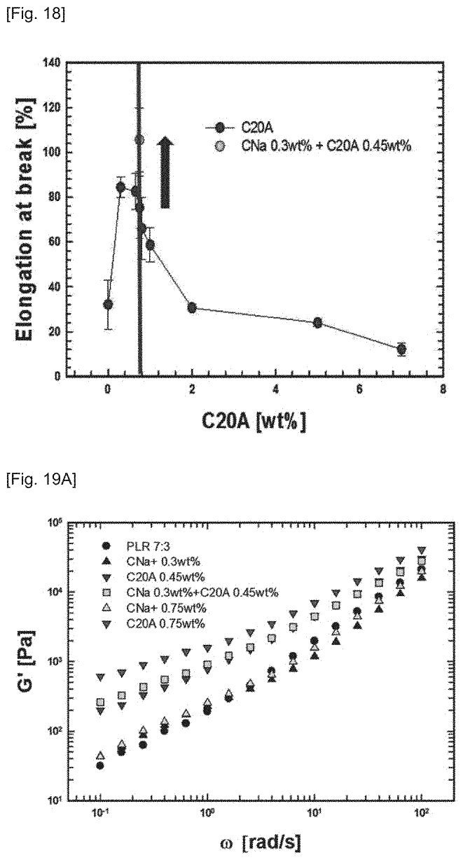

To evaluate the degree of change in tensile elongation when a mixture of organic clay (C20A) and natural clay (CNa⁺) was added to the PLA/NR (7:3) blend, for the biodegradable polymer composite of Example 12-2 (PLA/NR (7:3) and C20A 0.45 wt %+CNa⁺ 0.3 wt %), a specimen was prepared as described in Experimental Example 10 to measure tensile elongation. The measurement results were shown in FIG. 18 in comparison with the graph of C20A in FIG. 17B.

FIG. 18 shows the degree of increase in tensile elongation when a mixture of organic clay (C20A) and natural clay (CNa⁺) was added to a PLA/NR (7:3) blend. It can be seen that the use of CNa⁺ in a predetermined content range together with C20A in the polymer blend increases tensile elongation significantly.

### <Experimental Example 12> Analysis of Rheological Properties of PLA/NR Polymer Blends According to the Single or Combined Use of Organic Clay or Natural Clay

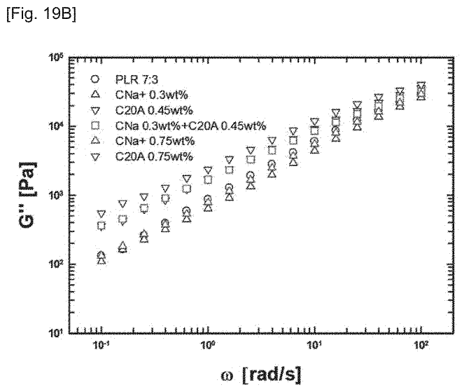

For the composite of Example 12-2 and Comparative Example 10 and Examples 13-1 to 13-4, where PLA/NR was mixed at a weight ratio of 7:3, a specimen was prepared as described in Experimental Example 1 to measure rheological properties. The measurement results are shown in FIGS. 19A and 19B.

FIGS. 19A and 19B show the measurement results of rheological properties (G, G″) according to the single or combined use of organic clay (C20A) and natural clay (CNa⁺) added to the PLA/NR (7:3) blend, respectively.

Specifically, in the case that natural clay (CNa⁺) was added alone in an amount of 0.3% by weight (Example 13-1) and 0.75% by weight (Example 13-3), the storage modulus (G′) and the loss modulus (G″) showed almost overlapping patterns, but rather decreased in the high frequency region, compared to the PLA/NR (7:3) blend (Comparative Example 10).

On the other hand, in the case that the organic clay (C20A) was added alone in an amount of 0.45% by weight (Example 13-2), the value of G′ was about 200 at a frequency of 0.1 rad/s, and in the case of 0.75% by weight (Example 13-4) the value of G′ was increased to about 600.

When both clays were added (Example 12-2), the value of G′ at a low frequency of 0.1 rad/s was slightly increased than the case where 0.45% by weight of C20A was added alone (Example 13-2), resulting in higher elasticity. On the other hand, the value of G′ was smaller than the case where 0.75% by weight of C20A was added alone (Example 13-4).

From these results, it can be seen that the combined use of organic clay (C20A) and natural clay (CNa⁺) provides rheological properties similar to the single use of organic clay (C20A).

### <Experimental Example 13> Morphology Analysis of PLA/NR Polymer Blends According to the Single or Combined Use of Organic Clay or Natural Clay

For the composites of Example 12-2 and Example 13-4 where PLA/NR was mixed at a weight ratio of 7:3, a specimen was prepared as described in Experimental Example 1 to observe the cross section by TEM.

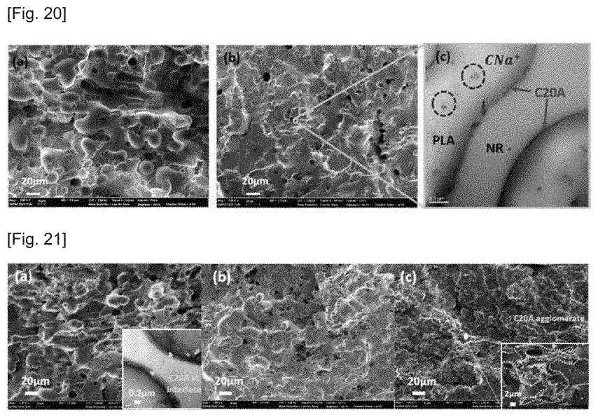

FIG. 20 is SEM and TEM images showing the morphology of the polymer composite based on PLA/NR/anisotropic particles (mixture of organic clay and natural clay) of Example 12-2 (FIGS. 20 (b) and (c)) and Example 12-3 (FIG. 20 (a)). From FIG. 20, it can be seen that the organic clay and the natural clay surround the interface of two incompatible polymers and some of them are present on the PLA. Although the particles of the two clays cannot be distinguished, some of them are peeled off and some of them form two or three layers. Peeling and dispersion are effectively performed without the need for particle identification. It is found that the peeled off and dispersed particles are located at the interface to stabilize the interface, and others are present on the PLA. The particles are not dispersed in the rubber phase, which is the second polymer. The particles are selectively dispersed at the interface and on the first polymer and bring about the effect of increasing rheological properties of the first polymer having low viscosity and the effect of reducing surface tension, causing change of the morphology from a spherical structure to fibril structure. In some cases, the two phases maintain a co-continuous structure.

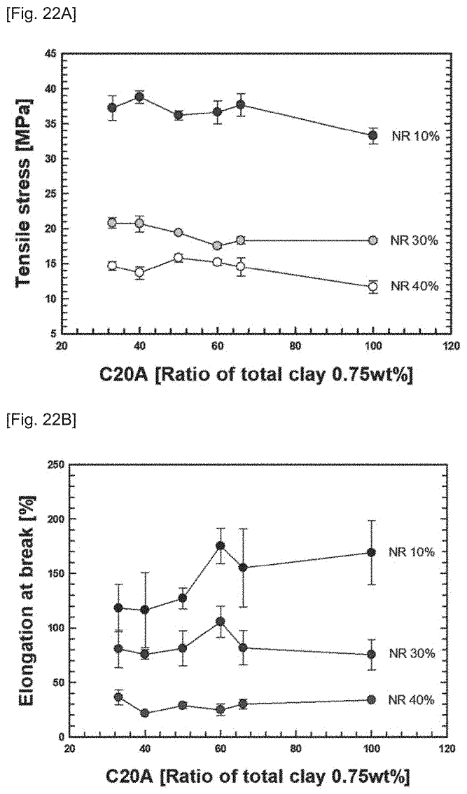

FIG. 21 is SEM and TEM images showing the morphology of the polymer composite based on PLA/NR/anisotropic particles (organic clay alone) according to Examples 13-2 (FIG. 21 (a)), 13-4 (FIG. 21 (b)) and 14-2 (FIG. 21 (c)). It can be seen that the organic clay particles having a plate-like structure are located at the interface between the dispersed phase (NR) and the main matrix (PLA) phase forming a continuous structure.

As shown in FIGS. 21 (a) and (b), the addition of a small amount of particles (<2 wt %) induces a significant change in morphology. When 0.45 wt % of organic clay (C20A) are added (FIG. 21(a)), the NR drops are significantly coarsened and connected each other. It mostly forms a co-continuous structure. With a slight increase in the content of C20A to 0.75 wt %, the blend shows a co-continuous structure homogeneously (FIG. 21(b)). It can attribute to the localization of organic clay (C20A) particles at the interface between PLA and NR (FIG. 21(a) inset).

As described above, when the organic clay is used alone or in combination with the natural clay, both of the PLA and NR are located at the interface between the two polymers, thereby inducing toughening of the blend. On the other hand, when the natural clay is used alone, it is mostly located on the first polymer and exhibits very little peeling-dispersion effect. However, when the natural clay is mixed with the organic clay, it exhibits the increased peeling-dispersion effect and changes the morphology of the blend along with the organic clay to induce toughening of the composite.

### <Experimental Example 14> Measurement of Changes in Mechanical Properties According to the Mixing Ratio of Organic Clay and Natural Clay

In order to analyze the effect of mixing ratio of two clays on the mechanical properties of the polymer composite based on PLA/NR/anisotropic particles (mixture of organic clay and natural clay), a specimen was prepared as described in Experimental Example 10 with changing the ratio of the organic clay in the composition of Experimental Examples 12-1 to 12-2 to measure tensile strength and tensile elongation.

FIGS. 22A and 22B are graphs showing tensile strength and tensile elongation according to the mixing ratio of PLA/NR and the content of organic clay of total content of clay for the polymer composite based on the PLA/NR/anisotropic particles (mixture of organic clay and natural clay), respectively.

From FIGS. 22A and 22B, it is found that the optimum mixing ratio of clay indicating the maximum tensile elongation is around 60% of the organic clay (C20A).

As such, the degree of toughening may vary depending on the ratio of C20A and CNa⁺ in the total amount of clay fixed according to each composition of PLA:NR, from which it is found that the mixture of anisotropic particles can control the interfacial properties of the polymer blend and derive optimal mechanical properties.

### <Example 15-1> Biodegradable Polymer Composite Based on PLA/NR/Anisotropic Particles (Hydrophobic Calcium Carbonate/Hydrophilic Calcium Carbonate Mixture)

Polylactic acid (PLA, 4032D, Mn=90,000 g/mol, Mw=181,000 g/mol, Natureworks, USA) as a first polymer forming a matrix, and natural rubber (NR, CSR5, Cambodia) as a second polymer forming a dispersed phase were used. As anisotropic particles, hydrophobic calcium carbonate (CaCO₃) particles coated with stearic acid (cPCC) and uncoated hydrophilic calcium carbonate (CaCO₃) particles (ucPCC) were used. At this time, the cPCC and ucPCC particles each had an average particle diameter of 100 nm. All materials were dried in a vacuum oven at 80° C. for one day to remove moisture. The materials were mixed at 100 rpm for 7 minutes at 200° C. using an intensive mixer (Rheocompmixer 600, MKE, Korea) in the amounts shown in Table 8 below.

Subsequently, a specimen was prepared as described in Experimental Example 10 to measure tensile elongation.

### <Example 15-2> Preparation of Biodegradable Polymer Composite Based on PLA/NR/Hydrophobic Calcium Carbonate

A polymer composite was prepared in the same manner in Example 15-1, except that uncoated hydrophilic calcium carbonate (CaCO₃) particles (ucPCC) were not used and the remaining ingredients were mixed in the amounts listed in Table 8 below.

TABLE 8

| | | | particle | | | |
|---|---|---|---|---|---|---|
| | | | (Based on the content of PLA) | | | |
| | | | cPCC | | ucPCC | Elongation |
| Part by | | | (hydrophobic | | (hydrophilic | at break |
| weight | PLA | NR | particle) | | particle) | point (%) |
| Example 15-1 | 85 | 15 | 3 | wt % | 3 wt % | 86% |
| Example 15-2 | 85 | 15 | 12 | w % | 0 | 85% |

From Table 8, it is found that when two kinds of calcium carbonates of hydrophilic particles and hydrophobic particles are mixed in the PLA/NR blend (Example 15-1), it is shown more improved tensile elongation, compared to the case of using only hydrophobic particles (Example 15-2). That is, in the case of spherical calcium carbonate, by using hydrophilic particles and hydrophobic particles having different surface properties together, it was possible to induce toughening without reducing other physical properties while lowering the content.

### <Example 16> Evaluation of Electrical Properties

To measure the electrical conductivity properties of the PCL/CB/PP-based polymer composite, the resistance value was measured for composite samples in which 7, 8.5, 10, 15, and 20 wt % of carbon black (CB) is added to the PCL matrix polymer, and composite samples in which 7, 8.5, 10, 15, and 20 wt % of CB is added to the blend of the PCL matrix polymer and the PP dispersed phase polymer.

The resistance measurement was performed on a sample (Disc) after a disk-shape molding (diameter 25 mm, thickness 0.4 mm) and a sample (Bulk) having a solid composite without undergoing any process after preparing the composite. The measurement results of resistance are shown in Table 9 below.

TABLE 9

| | | Resistance value [ohm] | | | |
|---|---|---|---|---|---|
| | CB content | Disc | | Bulk | |
| By weight | [wt %] | CB | CB/PP | CB | CB/PP |
| Example 16-1 | 7 | 10⁶~10⁷ | 10⁶ | 10¹² | 10¹² |
| Example 16-2 | 8.5 | 10⁶ | 10⁵ | 10¹² | 10¹² |
| Example 16-3 | 10 | 10⁵ | 10⁵ | 10¹¹~10¹² | 10¹² |
| Example 16-4 | 15 | 10⁵ | 10⁴ | 10⁷ | 10⁵ |
| Example 16-5 | 20 | 10³ | 10³ | 10³ | 10³ |

As can be seen from Table 9, above a certain content (7 wt %, electrical percolation threshold), addition of PP as a disperse phase showed a tendency to decrease the resistance value of the composite (i.e., increase conductivity). It is judged that this is because carbon black particles are aggregated not only in the matrix (PCL) but also in the PP dispersed matrix (droplet) above a certain content (it can be confirmed from SEM images). In addition, when PP as a disperse phase is added to the PCL/carbon black composite, the aggregation of CB particles occurs in the domain (droplet) of PP to form a percolation structure, thereby increasing the electrical conductivity of the composite.

### <Example 17> PLA/PCL/CB Composite

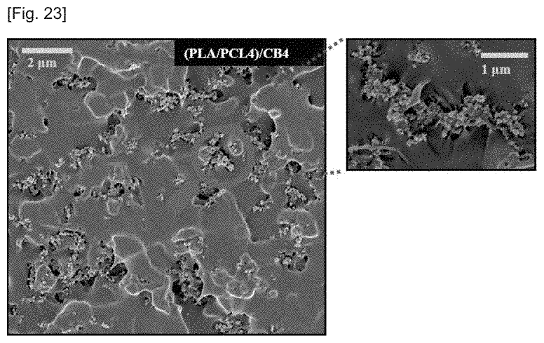

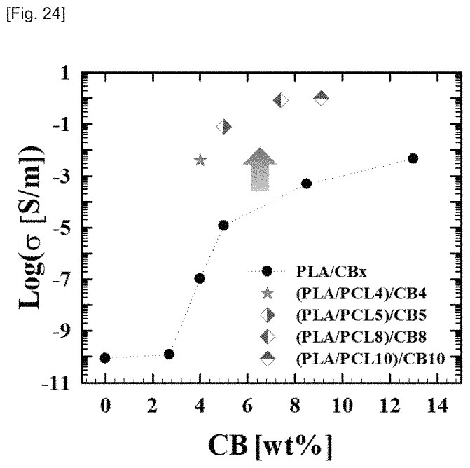

To measure the electrical conductivity properties of the PLA/PCL/CB composite with polylactic acid as a matrix and polycaprolactam as a dispersed phase, a composite with 4% by weight of PCL was prepared. The electrical conductivity was measured in the same manner as in Example 16. FIG. 23 is a SEM image showing the morphology of a (PLA/PCL4)/CB4-based polymer composite FIG. 24 shows the change in electrical conductivity of PLA/PCL/CB composites according to the carbon black content.

For the existing PLA/CB binary composites, more than 13 wt % of particles had to be added in order to realize conductivity of more than 10 order. However, for the ternary composite of (PLA/PCL4)/CB4, by adding only 4 wt % of PCL, it was possible to realize high conductivity with only a small amount of CB particles through accelerating particle aggregation.

### <Comparative Example 16> PP/HDPE/CB Composite

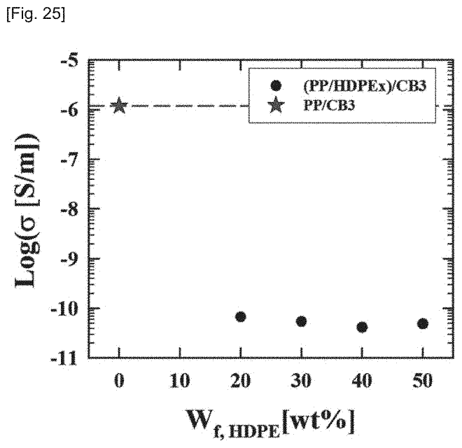

The measurement results of electrical conductivity with changing the content of carbon black with the mixing weight ratio of polypropylene and high-density polyethylene of 70:30, are shown in FIG. 25.

The surface energy difference between PP and CB is 20, which is greater than 10, and the surface energy difference between HDPE and CB is also 15, which is greater than 10. In this case, CB was not highly compatible with both PP and HDPE, and thus acceleration of particle aggregation was not observed. Therefore, despite the increase in the CB particle content, the electrical conducting network is not well established, so the electrical conductivity of the composite cannot be realized and shows insulating properties (FIG. 25).

While the present invention has been particularly shown and described with reference to specific embodiments thereof, it will be apparent to those skilled in the art that this specific description is merely a preferred embodiment and that the scope of the invention is not limited thereby. It is therefore intended that the scope of the invention be defined by the claims appended hereto and their equivalents.

What is claimed is:

1. A polymer composite comprising a plurality of particles dispersed in a matrix of a first polymer, wherein the particles are surrounded by a second polymer having a greater affinity to the particles than the first polymer to be connected each other, or arranged in a line along a dispersed phase of the second polymer.

2. The polymer composite according to claim 1, wherein the surface energy difference between the first polymer and the particle is larger than the difference between the second polymer and the particle.

3. The polymer composite according to claim 2, wherein the surface energy difference between the first polymer and the particle is in the range of 1 to 20 mJ/m² and the surface energy difference between the second polymer and the particle is in the range of 1 to 20 mJ/m².

4. The biodegradable polymer composite according to claim 1, wherein the surface energy difference between the first polymer and the particle is 10 mJ/m² or more, and the surface energy difference between the second polymer and the particle is less than 10 mJ/m².

5. The polymer composite according to claim 1, wherein when the dispersed phase is formed of the second polymer, the dispersed phase has a long diameter of 10 μm or less.

6. The polymer composite according to claim 1, wherein the first polymer and the second polymer have a viscosity ratio (second polymer/first polymer) of 10 or less as measured at a temperature of 30° C. higher than a melting temperature of the two polymers or at a temperature of 100° C. higher than a glass transition temperature of the two polymers.

7. The polymer composite according to claim 1, wherein the first polymer is selected from polylactic acid, polycaprolactone, polybutylene succinate, polybutylene adipate, polyethylene succinate, polyhydroxy alkylate and polyhydroxyalkanoate, or a mixture of two or more thereof.

8. The polymer composite according to claim 1, wherein the second polymer is selected from natural rubber, polyolefin, polyolefin elastomer, or a mixture of two or more thereof.

9. The polymer composite according to claim 1, wherein the polymer composite comprises the first polymer and the second polymer in a weight ratio of 99:1 to 60:40.

10. The polymer composite according to claim 1, wherein the polymer composite comprises particles in an amount of 0.3 to 46% by weight based on the total weight of the first polymer and the second polymer.

11. The polymer composite according to claim 1, wherein the weight ratio of the particle to the second polymer is 0.02:1 to 13:1.

12. The polymer composite according to claim 1, wherein when the particles are isotropic particles, the weight ratio of the particle to the second polymer is 0.5:1 to 2:1.

13. The polymer composite according to claim 1, wherein when the particles are anisotropic particles, the weight ratio of the particle to the second polymer is 0.02:1 to 0.4:1.

14. The polymer composite according to claim 1, wherein the average particle diameter of the particle is 1 μm or less.

15. The polymer composite according to claim 1, wherein the particle is at least one selected from the group consisting of clay, mica, talc, calcium carbonate, carbon black, carbon nanotubes, graphene, graphite, metal, and derivatives thereof.

16. The polymer composite according to claim 15, wherein the particle is carbon black, clay, calcium carbonate coated with stearic acid, or a mixture of two or more thereof.

17. The polymer composite according to claim 13, wherein the anisotropic particle is a mixture of hydrophobic organic clay and hydrophilic natural clay, or a mixture of hydrophobic calcium carbonate and hydrophilic calcium carbonate.

18. The polymer composite according to claim 17, wherein the natural clay is composed of anionically charged aluminum or magnesium silicate layers, and cations of sodium ions (Na+) or potassium ions (K+) filling between the anionically charged aluminum or magnesium silicate layers.

19. The polymer composite according to claim 17, wherein the natural clay is montmorillonite, hectorite, saponite, beidellite, nontronite, vermiculite, halloysite, or a mixture of two or more thereof.

20. The polymer composite according to claim 17, wherein the organic clay is organized by substituting ions existing on the surface or between the layers of the natural clay with hydrophobic functional groups.

21. The polymer composite according to claim 20, wherein the organic clay is organized with a material having an alkylammonium ion containing an alkyl group having 1 to 10 carbon atoms or a hydrophobic material of ω-amino acid (NH₂(CH₂)ₙ₋₁COOH, where n is an integer from 2 to 18).

22. The polymer composite according to claim 21, wherein the hydrophobic material is dimethyl dihydrogenated-tallow ammonium, dimethyl benzyl hydrogenated-tallow ammonium, dimethylhydrogenated-tallow (2-ethylhexyl) ammonium, or a mixture of two or more thereof.

23. The polymer composite according to claim 17, wherein the mixing weight ratio of the organic clay to the natural clay is 30:70 to 70:30.

24. The polymer composite according to claim 17, wherein the mixing weight ratio of the hydrophobic calcium carbonate particle and the hydrophilic calcium carbonate particle is 30:70 to 70:30.
